(19) United States
(12) Patent Application Publication
(10) Pub. No.: US 2026/0188277 A1
(43) Pub. Date: Jul. 2, 2026

(54) DISPLAY DEVICE

(71) Applicant: LG Display Co., Ltd., Seoul (KR)

(72) Inventors: HyunChul Kim, Paju-si (KR); SeRyong Park, Paju-si (KR); Jaemin You, Paju-si (KR); Eunjin Jun, Paju-si (KR)

(73) Assignee: LG Display Co., Ltd., Seoul (KR)

(21) Appl. No.: 19/281,849

(22) Filed: Jul. 28, 2025

(30) Foreign Application Priority Data
Dec. 26, 2024 (KR) 10-2024-0196586

(51) Int. Cl. G09G 3/36; G09G 3/3233; G09G 3/3266; G09G 3/3275

(52) U.S. Cl. CPC G09G 3/3688; G09G 3/3614; G09G 3/3677; G09G 3/3233; G09G 3/3266; G09G 3/3275; G09G 2310/0289; G09G 2330/021

(57) ABSTRACT

The present disclosure provides a display device including a display area in which an image is displayed and a plurality of subpixels are disposed, a non-display area located around an outer edge of the display area, a data driving circuit disposed in the non-display area and configured to supply data voltages to the plurality of subpixels, a gate driving circuit disposed in the non-display area and configured to supply a gate signal to the plurality of subpixels, and a controller configured to control the data driving circuit and the gate driving circuit. While image data is not supplied from the controller to the data driving circuit, at least one gate control signal supplied from the controller to the gate driving circuit may be supplied to the data driving circuit, and a same image may be displayed in the display area.

### CROSS REFERENCE TO RELATED APPLICATION

This application claims priority from Korean Patent Application No. 10-2024-0196586, filed on Dec. 26, 2024, in the Korean Intellectual Property Office, which is hereby incorporated by reference for all purposes as if fully set forth herein.

### BACKGROUND

### Technical Field

The present disclosure relates to electronic devices and, more specifically, to display devices.

### Description of Related Art

In today's information society, display devices for presenting images or visual information to users are increasingly important. The various needs for display devices have caused display technology to be rapidly developed, and indeed, various types of display devices, such as a liquid crystal display (LCD) device, an organic light emitting display (OLED) device, an inorganic light emitting display (iLED) device, a micro light emitting display (micro LED) device, a mini light emitting displays (mini LED) device, a quantum dot light emitting display (QLED) device, and the like, have been developed and widely used.

These display devices are desired to include a data driving circuit capable of being driven with low power by reducing power consumption and displaying images stably.

### SUMMARY

One or more aspects of the present disclosure may provide a display device configured to display a same image while image data is not provided by a controller to a data driving circuit.

One or more aspects of the present disclosure may provide a display device including a data driving circuit configured to generate a selection signal when a gate control signal is received from a controller.

Aspects, examples, and embodiments provided in the present disclosure are not limited to the foregoing description, and additional aspects, examples, and embodiments of the present disclosure will become apparent to those skilled in the art from the following description.

According to one or more example embodiments of the present disclosure, a display device can be provided that includes a display area in which an image is displayed and a plurality of subpixels are disposed, a non-display area located around an outer edge of the display area, a data driving circuit disposed in the non-display area and configured to supply data voltages to the plurality of subpixels, a gate driving circuit disposed in the non-display area and configured to supply a gate signal to the plurality of subpixels, and a controller configured to control the data driving circuit and the gate driving circuit. In one or more aspects, while image data is not supplied from the controller to the data driving circuit, at least one gate control signal supplied from the controller to the gate driving circuit may be supplied to the data driving circuit, and a same image may be displayed in the display area.

According to one or more example embodiments of the present disclosure, a display device can be provided that includes a display panel in which a plurality of subpixels are disposed, a data driving circuit configured to supply data voltages to the plurality of subpixels, a controller configured to control the data driving circuit, and a level shifter configured to receive a plurality of signals from the controller, change levels of the received plurality of signals or generate one or more other signals, and output the changed levels of the received plurality of signals or the generated one or more signals to the display panel. In one or more aspects, at least one signal among the plurality of signals supplied by the controller to the level shifter may be input to the data driving circuit.

According to one or more aspects of the present disclosure, a display device may be provided that is configured to not receive a selection signal for operation of a selection circuit from a controller.

According to one or more aspects of the present disclosure, a display device may be provided that does not include a pin for receiving a selection signal, and is configured to operate environmentally friendly.

Effects or advantages from aspects, examples, and embodiments described herein are not limited thereto, and additional effects or advantages will become apparent to those skilled in the art from the following description.

### BRIEF DESCRIPTION OF THE DRAWINGS

The accompanying drawings, which are included to provide a further understanding of the present disclosure and are incorporated in and constitute a part of the disclosure, illustrate aspects of the disclosure and together with the description serve to explain principles of the present disclosure. It should be therefore understood that aspects, examples, and embodiments described herein are not limited to the illustrations of the accompanying drawings. In the drawings:

FIG. 1 illustrates an example system configuration of a display device according to aspects of the present disclosure;

FIG. 2 illustrates an example configuration of the display device according to aspects of the present disclosure;

FIG. 3 illustrates an example equivalent circuit of a subpixel included in the display device according to aspects of the present disclosure;

FIG. 4 illustrates a configuration of an example source driver integrated circuit according to aspects of the present disclosure;

FIG. 5 illustrates an example logic circuit according to aspects of the present disclosure;

FIG. 6 illustrates example first and second logic circuits according to aspects of the present disclosure;

FIG. 7 illustrates an example truth table of the first and second logic circuits according to aspects of the present disclosure;

FIG. 8 is an example timing diagram for signals generated by the first and second logic circuits according to aspects of the present disclosure;

FIG. 9 illustrates an example third logic circuit according to aspects of the present disclosure;

FIG. 10 illustrates an example truth table of the third logic circuit according to aspects of the present disclosure;

FIG. 11 is an example timing diagram for signals generated by the third logic circuit according to aspects of the present disclosure;

FIG. 12 illustrates another example third logic circuit according to aspects of the present disclosure;

FIG. 13 illustrates an example truth table of another example third logic circuit according to aspects of the present disclosure;

FIG. 14 is an example timing diagram for signals generated by another example third logic circuit according to aspects of the present disclosure;

FIG. 15 is an example timing diagram for selection signals generated by a logic circuit according to aspects of the present disclosure;

FIG. 16 is an example structure of the display panel for sequentially supplying data voltages to a plurality of subpixels according to aspects of the present disclosure;

FIG. 17 is an example structure of the display panel for supplying data voltages to a plurality of subpixels in a zigzag pattern according to aspects of the present disclosure; and

FIG. 18 is an example structure of the display panel for supplying data voltages to a plurality of subpixels in another zigzag pattern according to aspects of the present disclosure.

### DETAILED DESCRIPTION

Reference will now be made in detail to example embodiments of the present disclosure, examples of which may be illustrated in the accompanying drawings.

In the following description, the structures, embodiments, implementations, methods and operations described herein are not limited to the specific example or examples set forth herein and may be changed as is known in the art, unless otherwise specified. Like reference numerals designate like elements throughout, unless otherwise specified. Names of the respective elements used in the following explanations are selected only for convenience of writing the specification and may thus be different from those used in actual products.

Advantages and features of the present disclosure, and implementation methods thereof will be clarified through following example embodiments described with reference to the accompanying drawings. The present disclosure may, however, be embodied in different forms and should not be construed as limited to the example embodiments set forth herein. Rather, these example embodiments are provided so that this disclosure may be sufficiently thorough and complete to assist those skilled in the art to fully understand the scope of the present disclosure. Further, the protected scope of the present disclosure may be defined by claims and their equivalents. In the following description, where the detailed description of the relevant known function or configuration may unnecessarily obscure aspects of the present disclosure, a detailed description of such known function or configuration may be omitted.

The shapes, sizes, ratios, angles, numbers, and the like, which are illustrated in the drawings to describe various example embodiments of the present disclosure, are merely given by way of example. Therefore, the present disclosure is not limited to the illustrations in the drawings.

The terms such as “including”, “having”, “containing”, “constituting”, “make up of”, and “formed of” used herein are generally intended to allow other components to be added unless the terms are used with a more limiting term like “only”. As used herein, singular forms are intended to include plural forms, and vice versa, unless the context clearly indicates otherwise.

Although the terms “first,” “second,” A, B, (a), (b), and the like may be used herein to describe various elements, these elements should not be interpreted to be limited by these terms as they are not used to define a particular order or precedence. These terms are used only to refer to one element separately from another. For example, a first element could be termed a second element, and, similarly, a second element could be termed a first element, without departing from the scope of the present disclosure.

Where it is mentioned that a first element “is connected or coupled to”, “contacts”, “overlaps with”, or the like a second element, it should be interpreted that, not only can the first element “be directly connected or coupled to”, “directly contact”, or “directly overlap with” the second element, but a third element can also be “interposed” between the first and second elements, or the first and second elements can “be connected or coupled to”, “contact”, “overlap with”, or the like each other via a fourth element. Here, the second element may be included in at least one of two or more elements that “are connected or coupled to”, “contact”, “overlap with”, or the like each other.

Where positional relationships are described, for example, where the positional relationship between two parts is described using “on,” “over,” “under,” “above,” “below,” “beside,” “next,” or the like, one or more other parts may be located between the two parts unless a more limiting term, such as “immediate(ly),” “direct(ly),” or “close(ly)” is used. For example, where an element or layer is disposed “on” another element or layer, a third element or layer may be interposed therebetween. Furthermore, the terms “left,” “right,” “top,” “bottom, “downward,” “upward,” “upper,” “lower,” and the like refer to an arbitrary frame of reference.

In addition, where any dimensions, relative sizes, and the like are mentioned, it should be considered that numerical values for an elements or features, or corresponding information (e.g., level, range, and the like) include a tolerance or error range that may be caused by various factors (e.g., process factors, internal or external impact, noise, and the like) even when a relevant description is not specified. Further, the term “may” fully encompasses all the meanings of the term “can”.

In the following description, various example aspects of the present disclosure are described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, aspects of the present disclosure are not limited to a scale, dimension, size, and thickness illustrated in the drawings.

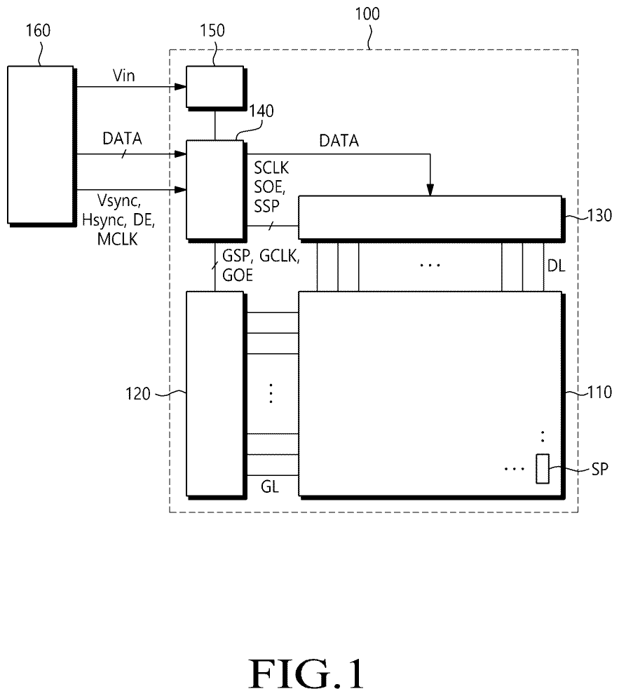

FIG. 1 illustrates an example system configuration of a display device 100 according to aspects of the present disclosure.

As shown in FIG. 1, in one or more example embodiments, the display device 100 may include a display panel 110 in which a plurality of gate lines GL and a plurality of data lines DL are disposed, and a plurality of subpixels SP are arranged in a matrix form, a gate driving circuit 120 configured to drive the plurality of gate lines GL, a data driving circuit 130 configured to supply data voltages through the plurality of data lines DL, a controller 140 configured to control the gate driving circuit 120 and the data driving circuit 130, and a power management circuit 150.

The display panel 110 may include a display area DA in which the plurality of subpixels SP are disposed, and a non-display area around an outer edge of the display area.

The display panel 110 may be configured to display images based on one or more scan signals and one or more emission control signals transmitted from the gate driving circuit 120 through the plurality of gate lines GL and data voltages transmitted from the data driving circuit 130 through the plurality of data lines DL.

In one or more aspects, in an example where the display device 100 is implemented as a liquid crystal display, the display panel 110 may include a liquid crystal layer formed between two substrates, and may be operated in an operating mode, such as a twisted nematic (TN) mode, a vertical alignment (VA) mode, an in-plane switching (IPS) mode, or a fringe field switching (FFS) mode. In one or more aspects, in an example where the display device 100 is implemented as a self-emissive display device such as an organic light emitting display or the like, the display panel 110 may be implemented in a top emission structure, a bottom emission structure, or a dual emission structure.

The display panel 110 may have a structure where the plurality of pixels are arranged in a matrix form. Each of the plurality of pixels may include subpixels SP of different colors, for example, at least one white subpixel, at least one red subpixel, at least one green subpixel, and at least one blue subpixel. The plurality of pixels may be defined by the plurality of data lines DL and the plurality of gate lines GL.

One subpixel SP may include a thin film transistor (TFT) formed in an area where a data line DL and at least one gate line GL intersect, a light emitting element, such as an organic light emitting diode or the like, that is capable of emitting light by a data voltage, a storage capacitor that is electrically connected to the light emitting element to maintain a voltage, and the like.

In an example where the display device 100 having a resolution of 2,160×3,840 includes a structure where a pluralities of four types of subpixels SP including a white subpixel W, a red subpixel R, a green subpixel G, and a blue subpixel B are arranged, 2,160 gate lines GL and a total of 15,360 data lines DL (i.e., 3,840×4=15,360) resulting from connecting each of 3,840 data lines DL to four types of subpixels WRGB may be disposed in the display device 100. In this example, subpixels SP may be disposed in areas where the 2,160 gate lines GL and the 15,360 data lines DL intersect each other.

The gate driving circuit 120, which may be controlled by the controller 140, can control driving times for a plurality of subpixels SP by sequentially outputting scan signals to a plurality of gate lines GL disposed on the display panel 110.

For example, the gate driving circuit 120 may include one or more gate driving integrated circuits GDIC, and be located only in one edge of the display panel 110 or on two or more edges thereof depending on design requirements or specifications. In one or more aspects, the gate driving circuit 120 may be implemented by a gate-in-panel (GIP) technique. In this configuration, the gate driving circuit 120 may be embedded into in a bezel area of the display panel 110.

The data driving circuit 130 can receive image data DATA from the controller 140, and convert the received image data DATA into analog data voltages. Thereafter, the data driving circuit 130 can output the data voltages to a plurality of data lines DL according to times at which the scan signals are applied through the gate lines GL. According to these configurations, each subpixel SP connected to a corresponding data line DL can emit light at luminance corresponding to a data voltage.

For example, the data driving circuit 130 may include one or more source driving integrated circuits SDIC. In this example, each source driving integrated circuit SDIC may be connected to a bonding pad of the display panel 110 or directly disposed in the display panel 110, by a tape-automated-bonding (TAB) technique or a chip-on-glass (COG) technique.

In one or more aspects, each source driving integrated circuit SDIC may be disposed to be integrated into the display panel 110. In one or more aspects, each source driving integrated circuit SDIC may be implemented in the display panel 110 by a chip-on-film (COF) technique. in this configuration, each source driving integrated circuit SDIC may be mounted on a circuit film and electrically connected to a data line DL of the display panel 110 through the circuit film.

The controller 140 can supply various control signals to the gate driving circuit 120 and the data driving circuit 130, and control operations of the gate driving circuit 120 and the data driving circuit 130. For example, the controller 140 can cause the gate driving circuit 120 to output scan signals at timings set for scanning corresponding one or more pixels. Further, the controller 140 can receive image data from an external device or system (e.g., a host system 160), convert the image data to a data signal form readable by the data driving circuit 130, and then supply image data DATA resulting from the converting to the data driving circuit 130.

For example, the controller 140 can receive various timing signals including a vertical synchronization signal Vsync, a horizontal synchronization signal Hsync, a data enable signal DE, a main clock MCLK, and the like, along with image data from the host system 160.

The host system 160 may be any one of a television (TV), a set top box, a navigation system, a personal computer (PC), a home theater system, a mobile device, a wearable device, and the like.

According to these configurations, the controller 140 can generate control signals using various timing signals received from the host system 160, and supply the control signals to the gate driving circuit 120 and the data driving circuit 130.

For example, the controller 140 can supply various gate control signals including a gate start pulse GSP, a gate clock GCLK, a gate output enable signal GOE, and the like to control the gate drive circuit 120. The gate start pulse GSP may be used to control a time at which one or more gate driving integrated circuits GDIC included in the gate drive circuit 120 start operating. The gate clock GCLK may be a clock signal commonly input to one or more gate driving integrated circuits GDIC and be used to control a shift time of a scan signal. The gate output enable signal GOE may be used to indicate time information of one or more gate driving integrated circuits GDIC.

The controller 140 can supply various data control signals including a source start pulse SSP, a source sampling clock SCLK, a source output enable signal SOE, and the like to control the data driving circuit 130. The source start pulse SSP may be used to control a time at which one or more source driving integrated circuits SDIC included in the data driving circuit 130 start data sampling. The source sampling clock SCLK may be a clock signal for controlling a time at which one or more source driving integrated circuits SDIC sample data. The source output enable signal SOE may be used to control an output time of the data driving circuit 130.

The display device 100 may include a power management circuit 150 configured to supply various voltages or currents to the display panel 110, the gate driving circuit 120, the data driving circuit 130, and the like, or control various voltages or currents to be supplied.

The power management circuit 150 can adjust an input direct current or voltage Vin supplied by the host system 160 and generate voltages or currents for driving the display panel 110, the gate driving circuit 120, and the data driving circuit 130.

Subpixels SP may located at locations where gate lines GL and data lines DL intersect each other, and a respective light emitting element may be disposed in each subpixel SP. In an example where the display device 100 is implemented as organic light emitting display device including organic light emitting elements such as organic light emitting diodes or the like, the display device 100 may include light emitting elements disposed in subpixels SP, and can display images by controlling current flowing to the light emitting elements according to data voltages.

In one or more aspects, the display device 100 may be various types of devices such as a liquid crystal display, an organic light emitting display, a plasma display panel, and the like.

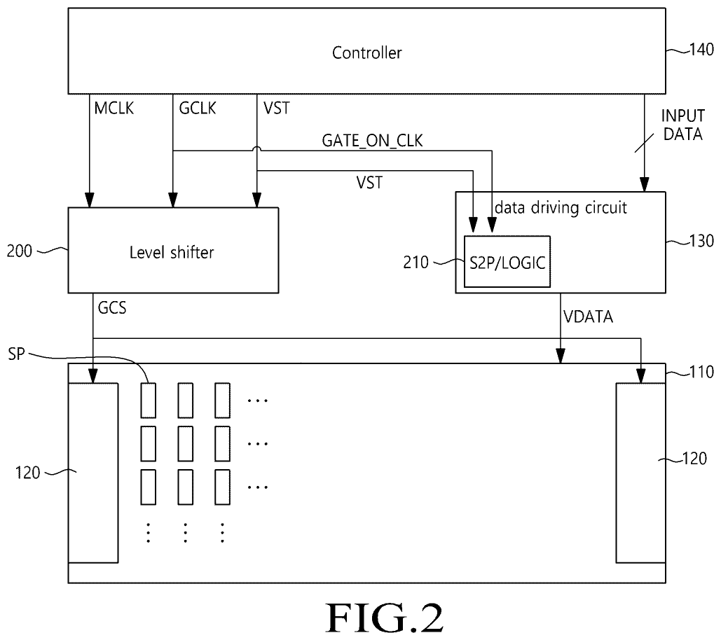

FIG. 2 illustrates an example configuration of the display device 100 according to aspects of the present disclosure.

As shown in FIG. 2, in one or more example embodiments, the display device 100 may include the display panel 110, the gate driving circuit 120, the data driving circuit 130, the controller 140, and a level shifter 200.

The data driving circuit 130 may include a plurality of source driving integrated circuits SDIC. Each of the plurality of source driving integrated circuits SDIC may include a receiving circuit 210. The receiving circuit 210 may include a serial-to-parallel circuit S2P, and a logic circuit LOGIC.

In discussions that follow for the configuration of FIG. 2, discussions for features equal, substantially equal, or similar to the features described with reference to FIG. 1 are omitted for conciseness.

The controller 140 can supply a plurality of signals, such as a main clock MCLK, a gate clock GCLK, and a start signal VST, for controlling the gate driving circuit 120 to the level shifter 200. The gate clock GCLK may include a gate on clock signal GATE_ON_CLK and a gate off clock signal GATE_OFF_CLK. The plurality of signals may be referred to as gate control signals GCS.

The level shifter 200 can change voltage levels of the plurality of signals supplied by the controller 140. The level shifter 200 can supply the plurality of gate control signals GCS whose voltage levels are changed to the gate driving circuit 120.

The level shifter 200 can generate at least one gate control signal GCS based on the plurality of signals supplied by the controller 140. The level shifter 200 can supply the generated at least one gate control signal GCS to the gate driving circuit 120.

The level shifter 200 can change a corresponding voltage level of one or more of the plurality of signals supplied by the controller 140 to another voltage level, and use one or more of the plurality of signals to generate a gate control signal GCS. In this configuration, the signal whose voltage level is changed or the generated gate control signal GCS may be supplied to the gate driving circuit 120.

In one or more aspects, the level shifter 200 may be omitted. In this configuration, the controller 140 can directly supply a corresponding gate control signal GCS to the display panel 110.

The controller 140 can supply at least one or more of the signals supplied to the level shifter 200 to the data driving circuit 130. For example, the controller 140 can supply the gate on clock signal GATE_ON_CLK, which is one type of the gate clock GCLK, and the start signal VST to the data driving circuit 130. These supplied signals may be input to the receiving circuit 210.

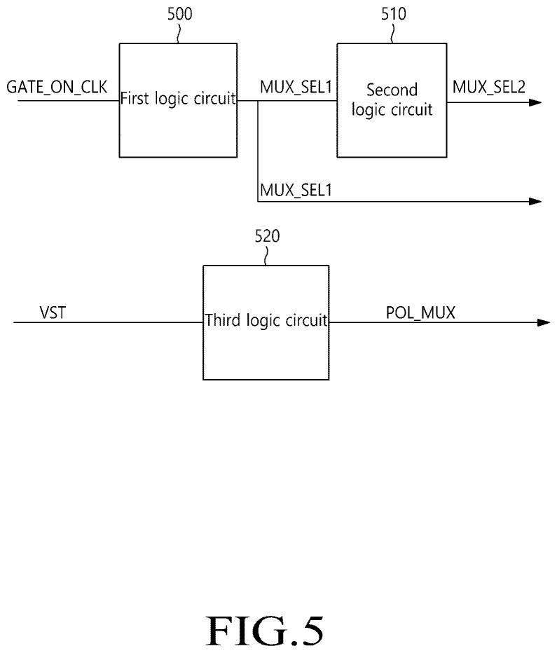

The data driving circuit 130 can generate at least one selection signal SEL using at least one or more of the input signals. Detailed description related to the selection signal SEL is provided below with reference to FIG. 5.

The data driving circuit 130 can supply data voltages VDATA to the display panel 110 based on the generated at least one selection signal.

The controller 140 can supply input data (INPUT DATA) to the data driving circuit 130. The input data (INPUT DATA) may include image data DATA and clock signals for adjusting times for supplying the image data DATA.

It should be noted here that while a still image is displayed in the display area DA, the data driving circuit 130 can supply data voltages VDATA to the display panel 110 using stored image data DATA even when input data (INPUT DATA) is not provided to the data driving circuit 130.

Accordingly, when a still screen is presented on the display panel 110, to drive the display device 100 at low power, the controller 140 may not supply input data (INPUT DATA) and the data driving circuit 130 may not receive input data (INPUT DATA). According to this configuration, transmission and/or reception operation between the controller 140 and the data driving circuit 130 may be interrupted for a certain period of time.

Such a still screen may be referred to as a screen presented for one or more horizontal periods (H) for which an equal data voltage VDATA is supplied to a plurality of subpixels SP included in the display panel 110. The still screen may be referred to as a screen in which the same image is displayed in the display area DA for a certain period of time.

For example, even when an equal data voltage VDATA is supplied to a plurality of subpixels SP, a data voltage VDATA output from each of the plurality of source driving integrated circuits SDIC may be changed according to the at least one selection signal. For example, depending on a type of the display panel 110, subpixels receiving data voltages VDATA supplied by a specific source driving integrated circuit SDIC may be changed based on a driving period.

Since the data driving circuit 130 does not receive input data (INPUT DATA) including a selection signal or a signal for generating the selection signal, the source driving integrated circuit SDIC may need the at least one selection signal SEL. For example, the at least one selection signal may be needed differently depending on methods of supplying data voltages VDATA to the plurality of subpixels SP in the display panel 110. For example, depending on an order in which a specific source driving integrated circuit SDIC supplies data voltages VDATA to a plurality of subpixels SP, the source driving integrated circuit SDIC may need different selection signals.

For example, the data driving circuit 130 may change columns to be supplied with data voltages VDATA based on a predefined period.

According to this configuration, the source driving integrated circuits SDIC may alternately supply different data voltages VDATA to the plurality of subpixels SP based on a predefined period. For example, the source driving integrated circuits SDIC may supply data voltages VDATA to the plurality of subpixels SP on a column basis (i.e., in a column direction), a Z-shape pattern, a nonlinear pattern, or a zig-zag pattern.

For example, depending on image display methods of the display panel 110 and displayed images, data voltages VDATA output by a source driving integrated circuit SDIC in a first column may be supplied to subpixels SP disposed in another column (for example, a second column).

As described above, when at least one signal among the plurality of signals supplied by the controller 140 to the level shifter 200 is received, and at least one selection signal is generated using the at least one signal, a separate pin for receiving the selection signal from the controller 140 may not needed to be disposed in the data driving circuit 130.

For example, since at least one or more of gate control signals GCS are used by the data driving circuit 130 to generate at least one selection signal, a configuration (e.g., a connection line) between the data driving circuit 130 and the controller 140 may not be needed. In addition, while a still screen is displayed, data transmission and reception dedicated exclusively between the controller 140 and the data driving circuit 130 may not be needed.

Hereinafter, discussions for a subpixel SP supplied with a data voltage VDATA are provided.

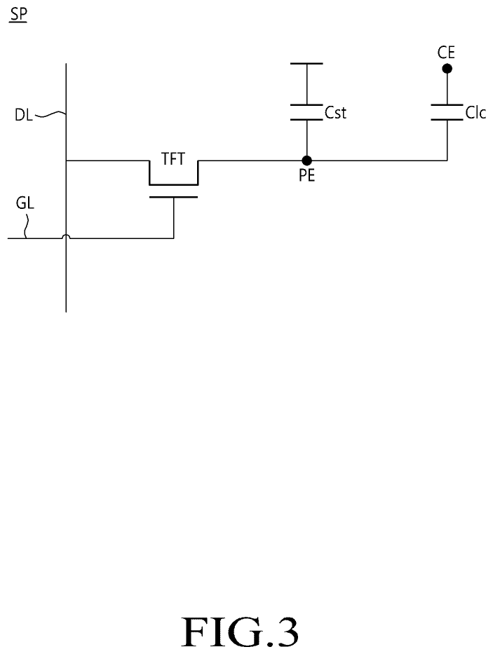

FIG. 3 illustrates an example equivalent circuit of a subpixel SP included in the display panel 110 according to aspects of the present disclosure.

As shown in FIG. 3, in one or more example embodiments, a subpixel SP may include a thin film transistor TFT, a storage capacitor Cst, and a liquid crystal cell Clc. The liquid crystal cell Clc may include a common electrode CE, and a pixel electrode PE.

The thin film transistor TFT may be electrically connected to a data line DL, and a gate node of the thin film transistor TFT may be electrically connected to a gate line GL. The thin film transistor TFT may be supplied with a data voltage VDATA through the data line DL. An electrical connection of the thin film transistor TFT may be controlled by a gate signal delivered through the gate line GL. The gate signal may be determined by a gate control signal GCS.

The liquid crystal cell Clc can be driven by a voltage difference between the common electrode CE to which a common voltage is applied and the pixel electrode PE in which a data voltage VDATA is charged, and can present an image by adjusting an amount of light transmitted. The storage capacitor Cst can maintain a voltage of the liquid crystal cell Clc.

The subpixel SP of FIG. 3 is only an example, and an organic light emitting diode (OLED)-based subpixel SP or a quantum dot-based subpixel SP may be included in the display device 100 or the display panel 110.

The number of transistors or the number of capacitors included in the subpixel SP may be changed depending on types of the display panel 110.

Hereinafter, discussions for an example source drive integrated circuit SDIC configured to apply a data voltage VDATA to the data line DL of the subpixel SP are provided.

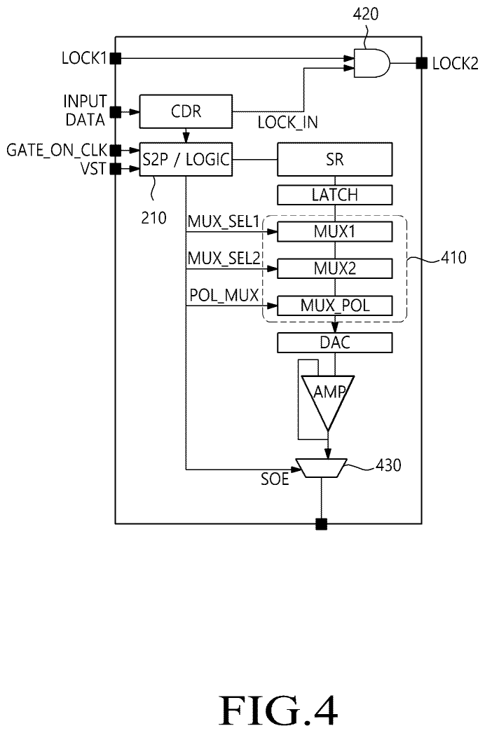

FIG. 4 illustrates a configuration of an example source driver integrated circuit SDIC according to aspects of the present disclosure.

As shown in FIG. 4, in one or more example embodiments, a source drive integrated circuit SDIC may include a clock data recovery circuit CDR, a receiving circuit 210, a shift register SR, a latch circuit LATCH, a selection circuit 410, a comparison circuit 420, a digital-to-analog converter DAC, an amplifying circuit AMP, and an output buffer 430.

The selection circuit 410 may include a first selection circuit MUX1, a second selection circuit MUX2, and a polarity selection circuit MUX_POL. In one or more aspects, depending on types of the display panel 110, at least one of the components (e.g., the first selection circuit MUX1, the second selection circuit MUX2, and the polarity selection circuit MUX_POL) in the selection circuit 410 may be omitted. In one or more aspects, depending on types of the display panel 110, the selection circuit 410 may be omitted.

For example, when data voltages VDATA are supplied to a plurality of subpixels SP only on a column basis (i.e., a column direction), the selection circuit 410 may be omitted and a selection signal may not be generated. However, even when data voltages VDATA are supplied only on a column basis (i.e., the column direction), when the gate driving circuit 120 controls emission times of the plurality of subpixels SP, at least one selection circuit 410 may be needed to supply different data voltages VDATA based on one or more rows.

For example, when the display panel 110 is not a display panel included in a liquid crystal display (LCD), the polarity selection circuit MUX_POL may be omitted, and a polarity selection signal POL_MUX may not be generated.

Hereinafter, discussions for the display device 100 may be provided based on a display device including an LCD display panel 110 configured to generate the polarity selection signal POL_MUX. However, it should be noted that this is not intended to exclude examples where different types of display panels 110 are used.

The receiving circuit 210 may include a serial-to-parallel circuit S2P, and a logic circuit LOGIC.

For example, the source driving integrated circuit SDIC may receive a first lock signal LOCK1 from another source driving integrated circuit SDIC or the controller 140. The received first lock signal LOCK1 may be transferred to the comparison circuit 420.

The clock recovery circuit CDR can receive input data (INPUT DATA) from the controller 140. Input data (INPUT DATA) may include image data DATA and data for restoring a clock signal for driving the source drive integrated circuit SDIC.

The clock recovery circuit CDR can recover the clock signal using the input data (INPUT DATA). The clock recovery circuit CDR can transmit an internal lock signal LOCK_IN to the comparison circuit 420 based on the recovered clock signal.

The comparison circuit 420 can determine whether the recovery operation of the clock recovery circuit CDR is performed normally using the first lock signal LCOK1 and the internal lock signal LOCK_IN. The comparison circuit 420 can supply whether the recovery is performed normally to the controller 140 through a second lock signal LOCK2. The comparison circuit 420 can supply the second lock signal LOCK2 to another source driving integrated circuit SDIC.

For example, when the clock signal is restored normally, the comparison circuit 420 can supply the second lock signal LOCK2 of a high signal level to another source driving integrated circuit SDIC.

For example, when the clock signal is abnormally restored, the comparison circuit 420 can transmit the second lock signal LOCK2 of a low signal level to the controller 140. In this situation, the controller 140 can supply input data INPUT DATA to the source drive integrated circuit SDIC again.

The receiving circuit 210 can receive data including image data DATA received by the clock recovery circuit CDR. The receiving circuit 210 can receive a gate on clock signal GATE_ON_CLK and a start signal VST from the controller 140.

The serial-to-parallel circuit S2P can parallelize the received data and supply the resulting data to the shift register SR, the latch LATCH, the selection circuit 410, and the output buffer 430.

The logic circuit LOGIC can generate selection signals (e.g., a first selection signal MUX_SEL1, a second selection signal MUX_SEL2, and/or a polarity selection signal POL_MUX) to be supplied to the selection circuit 410 based on the gate on clock signal GATE_ON_CLK and the start signal VST. The selection signals may be output to the selection circuit 410.

The shift register SR can generate a sampling signal in response to an input signal (e.g., a source start pulse SSP).

The latch circuit LATCH can sequentially sample image data DATA based on the sampling signal and supply the resulting image data DATA to the selection circuit 410. The latch circuit LATCH may be referred to as a latch array.

The selection circuit 410 can select image data DATA to be supplied to the digital-to-analog converter DAC among the image data DATA. The selected image data DATA may be supplied to the digital-to-analog converter DAC.

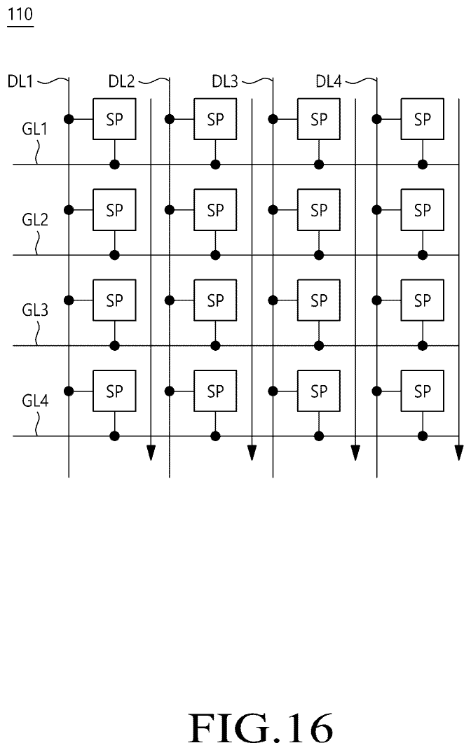

In this configuration, the selection circuit 410 can select image data DATA latched in another source driving integrated circuit SDIC. Accordingly, while image data DATA is not received from the controller 140, another data voltage VDATA may be output from the same source driving integrated circuit SDIC. Even when another data voltage VDATA is output, a still image may be displayed on the display panel 110. Discussions for an order in which data voltages VDATA are supplied to present a still image by a plurality of subpixels SP are discussed below with reference to FIG. 16 and figures following FIG. 16.

For example, the first selection circuit MUX1 may operate based on the first selection signal MUX_SEL1, the second selection circuit MUX2 may operate based on the second selection signal MUX_SEL2, and the polarity selection circuit MUX_POL may operate based on the polarity selection signal POL_MUX.

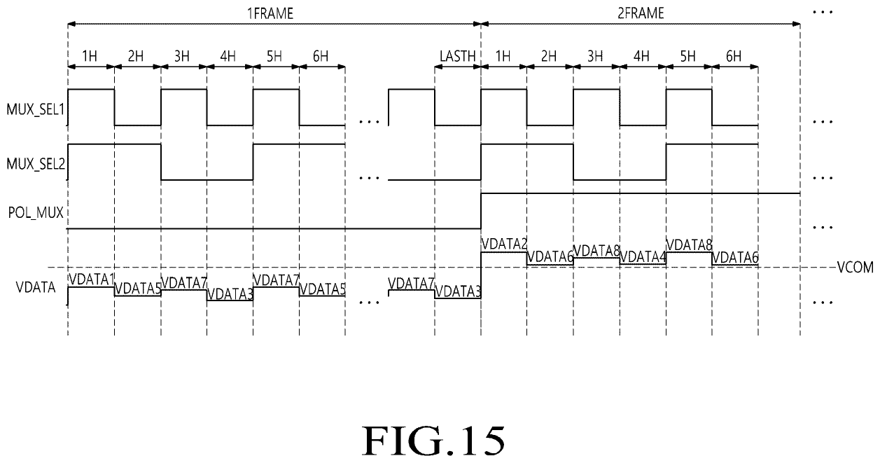

Discussions for example data voltages VDATA output by the operation of the selection circuit 410 are provided with reference to FIG. 15.

Discussions for an example operation of the logic circuit LOGIC for generating the first selection signal MUX_SEL1, the second selection signal MUX_SEL2, and the polarity selection signal POL_MUX are provided with reference to FIG. 5 and figures following FIG. 5.

The digital-to-analog converter DAC can convert supplied digital image data DATA into analog data voltage VDATA.

The amplifying circuit AMP can amplify a voltage level of the data voltage VDATA.

The output buffer 430 can output the data voltage VDATA to the display panel 110 in response to a source output enable signal SOE.

Hereinafter, discussions for an example logic circuit LOGIC configured to generate selection signals are provided.

FIG. 5 illustrates an example logic circuit LOGIC according to aspects of the present disclosure.

As shown in FIG. 5, in one or more example embodiments, a logic circuit LOGIC (e.g., the logic circuit LOGIC of FIG. 4) may include a first logic circuit 500, a second logic circuit 510, and a third logic circuit 520.

The logic circuit LOGIC can generate at least one selection signal using at least one signal supplied by the controller 140.

For example, the first logic circuit 500 can generate the first selection signal MUX_SEL1 based on a gate on clock signal GATE_ON_CLK supplied by the controller 140. The first selection signal MUX_SEL1 may be output to the second logic circuit 510. The first selection signal MUX_SEL1 may be output to the first selection circuit MUX1.

For example, the second logic circuit 510 can generate the second selection signal MUX_SEL2 using the first selection signal MUX_SEL1. The second selection signal MUX_SEL2 may be output to the second selection circuit MUX2.

For example, the third logic circuit 520 can generate the polarity selection signal POL_MUX using a start signal VST supplied by the controller 140. The generated polarity selection signal POL_MUX may be output to the polarity selection circuit MUX_POL.

Discussions for the configuration and operation of the logic circuits are provided below.

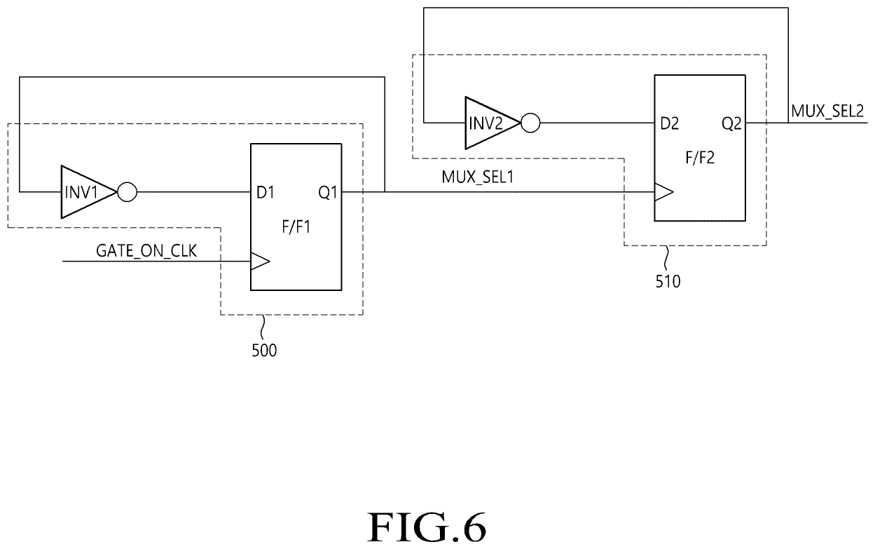

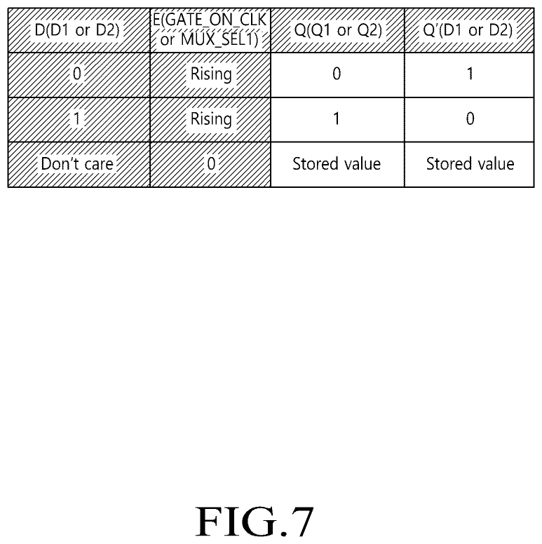

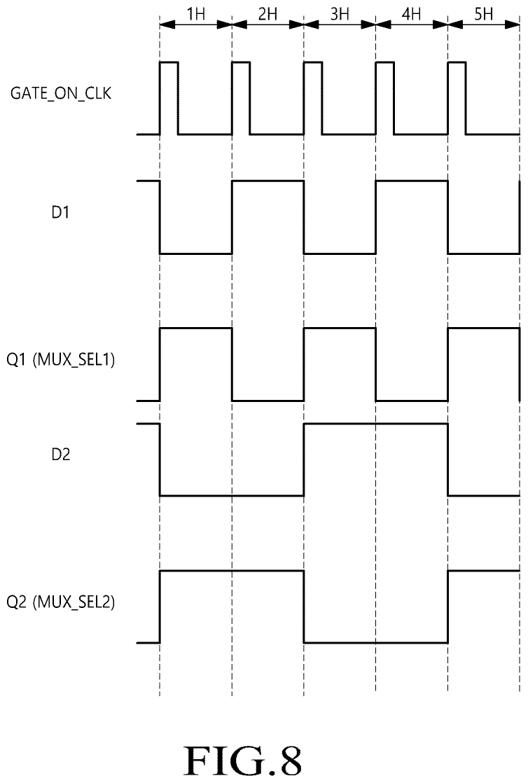

FIG. 6 illustrates example configurations of the first and second logic circuits (500 and 510) according to aspects of the present disclosure. FIG. 7 illustrates an example truth table of the first and second logic circuits (500 and 510) according to aspects of the present disclosure. FIG. 8 is an example timing diagram for signals generated by the first and second logic circuits (500 and 510) according to aspects of the present disclosure.

As shown in FIG. 6, in one or more example embodiments, the first logic circuit 500 may include a first flip-flop F/F1 and a first inverter INV1.

The first flip-flop F/F1 may include a first input node D1 and a first output node Q1, and receive the gate on clock signal GATE_ON_CLK. The first inverter INV1 may be connected between the first input node D1 and the first output node Q1, and can invert a signal. According to these configurations, respective signals of the first input node D1 and the first output node Q1 may be signals inverted from each other.

The second logic circuit 510 may include a second flip-flop F/F2 and a second inverter INV2.

The second flip-flop F/F2 may include a second input node D2 and a second output node Q2, and receive the first selection signal MUX_SEL1. The second inverter INV2 may be connected between the second input node D2 and the second output node Q2, and can invert a signal. According to these configurations, respective signals of the second input node D2 and the second output node Q2 may be signals inverted from each other.

As shown in FIG. 7, in one or more example embodiments, the first flip-flop F/F1 may be controlled based on a rising edge of the gate on clock signal GATE_ON_CLK. Whenever a rising edge of the gate on clock signal GATE_ON_CLK occurs, respective values of the first input node D1 and the first output node Q1 may be changed. For example, if a rising edge occurs on the gate-on-clock signal GATE_ON_CLK while the first input node D1 has a value of 0, the signal at the first input node D1 may change to a value of 1 (e.g., corresponding to Q′ in the truth table), and the signal at the first output node Q1 may change to a value of 0 (e.g., corresponding to Q in the truth table). For example, if a rising edge occurs on the gate-on clock signal GATE_ON_CLK while the first input node D1 has a value of 1, the signal at the first input node D1 may change to a value of 0 (e.g., corresponding to Q′ in the truth table) and the signal at the first output node Q1 may change to a value of 1 (e.g., corresponding to Q in the truth table).

The second flip-flop F/F2 may be controlled according to a rising edge of the first selection signal MUX_SEL1. Whenever a rising edge of the first selection signal MUX_SEL1 occurs, respective values of the second input node D2 and the second output node Q2 may be changed.

For example, when a rising edge of the gate on clock signal GATE_ON_CLK and a rising edge of the first selection signal MUX_SEL1 do not occur in the first flip-flop F/F1 and the second flip-flop F/F2, respectively, the first flip-flop F/F1 and the second flip-flop F/F2 may have stored values, which are not changed.

As shown in FIG. 8, in one or more example embodiments, horizontal periods (1H, 2H, 3H, 4H, 5H) may be defined according to rising edges of the gate on clock signal GATE_ON_CLK.

Respective values of the first input node D1 and the first output node Q1 of the first flip-flop F/F1 may be changed whenever a rising edge of the gate on clock signal GATE_ON_CLK occurs.

For example, in a situation where the first input node D1 has a value of 1 and the first output node Q1 has a value of 0, when a rising edge of the gate on clock signal GATE_ON_CLK occurs, in the first flip-flop F/F1, the value of the first input node D1 may be changed to a value of 0, and the value of the first output node Q1 may be changed to a value of 1. The value of the first output node Q1 may be the value of the first selection signal MUX_SEL1.

For example, in a situation where the first input node D1 has a value of 0 and the first output node Q1 has a value of 1, when a rising edge of the gate on clock signal GATE_ON_CLK occurs, in the first flip-flop F/F1, the value of the first input node D1 may be changed to a value of 1 and the value of the first output node Q1 may be changed to a value of 0. The value of the first output node Q1 may be the value of the first selection signal MUX_SEL1.

Respective values of the second input node D2 and the second output node Q2 of the second flip-flop F/F2 may be changed whenever a rising edge of the first selection signal MUX_SEL1 occurs.

For example, in a situation where the second input node D2 has a value of 1 and the second output node Q2 has a value of 0, when a rising edge of the first selection signal MUX_SEL1 occurs, in the second flip-flop F/F2, the value of the second input node D2 may be changed to a value of 0 and the value of the second output node Q2 may be changed to a value of 1. The value of the second output node Q2 may be the value of the second selection signal MUX_SEL2.

For example, in a situation where the second input node D2 has a value of 0 and the second output node Q2 has a value of 1, when a rising edge of the first selection signal MUX_SEL1 occurs, in the second flip-flop F/F2, the value of the second input node D2 may be changed to a value of 1 and the value of the second output node Q2 may be changed to a value of 0. The value of the second output node Q2 may be the value of the second selection signal MUX_SEL2.

Accordingly, the period of the first selection signal MUX_SEL1 may be half the period of the second selection signal MUX_SEL2.

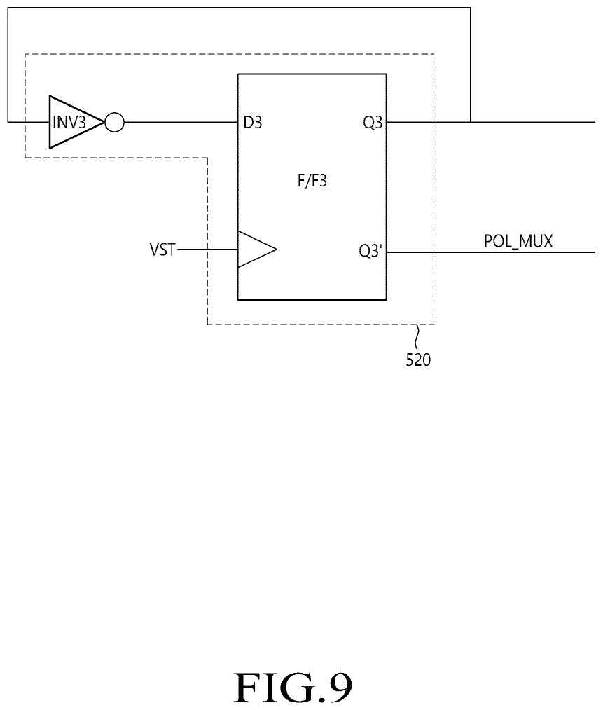

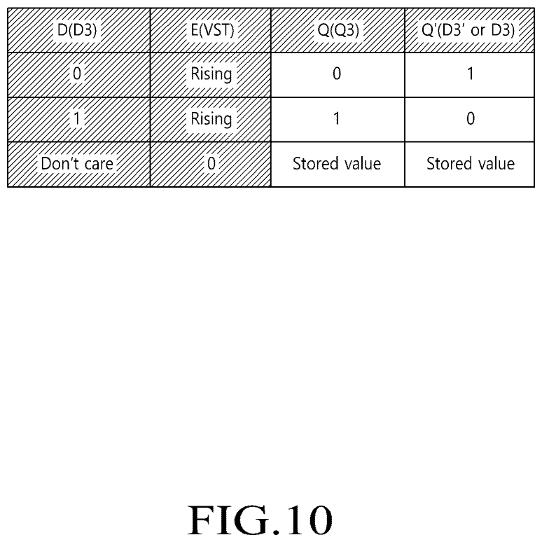

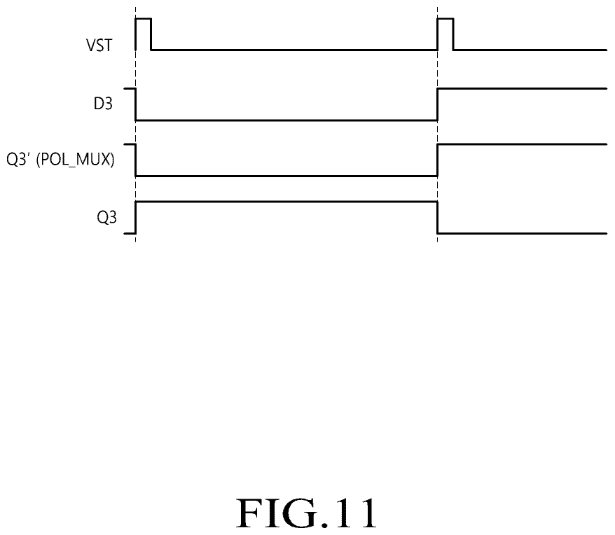

FIG. 9 illustrates an example configuration of the third logic circuit 520 according to aspects of the present disclosure. FIG. 10 illustrates an example truth table of the third logic circuit 520 according to aspects of the present disclosure. FIG. 11 is an example timing diagram for signals generated by the third logic circuit 520 according to aspects of the present disclosure.

As shown in FIG. 9, in one or more example embodiments, the third logic circuit 520 may include a third flip-flop F/F3 and a third inverter INV3.

The third flip-flop F/F3 may include a third input node D3, a third output node Q3, and a third inverted output node Q3′, and can receive the start signal VST. The third inverter INV3 may be connected between the third input node D3 and the third output node Q3, and can invert a signal. According to these configurations, respective signals of the third input node D3 and the signal of the third output node Q3 may be signals inverted from each other. Respective signals of the third output node Q3 and the third inverted output node Q3′ may be signals inverted from each other.

As shown in FIG. 10, in one or more example embodiments, the third flip-flop F/F3 may be controlled according to a rising edge of the start signal VST. Whenever a rising edge of the start signal VST occurs, respective values of the third input node D3, the third inverted output node Q3′, and the third output node Q3 may be changed. For example, While the value of the signal of the third input node D3 is 0, when the rising edge of the start signal VST occurs, the value of the signal of the third input node D3 changes to 1 (e.g., corresponding to Q′ in the truth table), and the value of the signal of the third output node Q3 may change to 0 (e.g., corresponding to Q in the truth table). For example, While the value of the signal of the third input node D3 is 1, when the rising edge of the start signal VST occurs, the value of the signal of the third input node D3 changes to 0 (e.g., corresponding to Q′ in the truth table), and the value of the signal of the third output node Q3 may change to 1 (e.g., corresponding to Q in the truth table).

For example, when a rising edge of the start signal VST does not occurs, the third flip-flop F/F3 may have a stored value, which is not changed.

As shown in FIG. 11, in one or more example embodiments, for example, respective values of the third input node D3, the third inverted output node Q3′, and the third output node Q3 of the third flip-flop F/F3 may be changed when a rising edge of the start signal VST occurs.

For example, in a situation where the third input node D3 has a value of 1, the third output node Q3 has a value of 0, and the third inverted output node Q3′ has a value of 1, when a rising edge of the start signal VST occurs, in the third flip-flop F/F3, the value of the third input node D3 may be changed to a value of 0, the value of the third output node Q3 may be changed to a value of 1, and the value of the third inverted output node Q3′ may be changed to a value of 0. The value of the third inverted output node Q3′ may be the value of the polarity selection signal POL_MUX.

For example, in a situation where the third input node D3 has a value of 0, the third output node Q3 has a value of 1, and the third inverted output node Q3′ has a value of 0, when a rising edge of the start signal VST occurs, in the third flip-flop F/F3, the value of the third input node D3 may be changed to a value of 1, the value of the third output node Q3 may be changed to a value of 0, and the value of the third inverted output node Q3′ may be changed to a value of 1. The value of the third inverted output node Q3′ may be the value of the polarity selection signal POL_MUX.

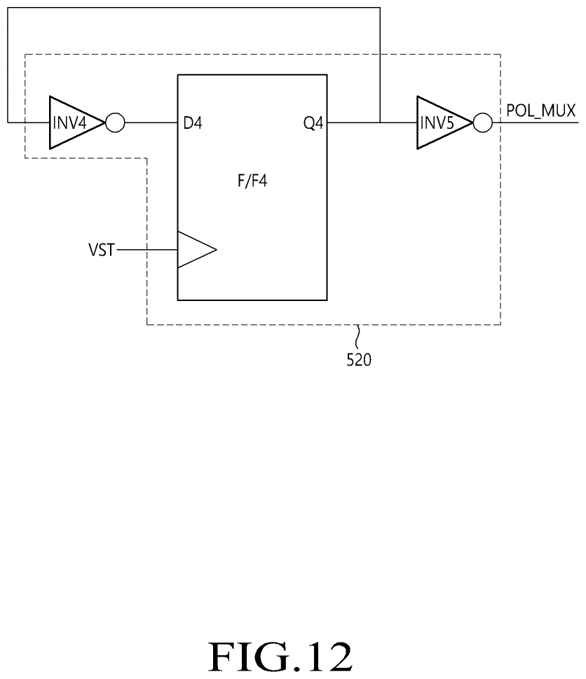

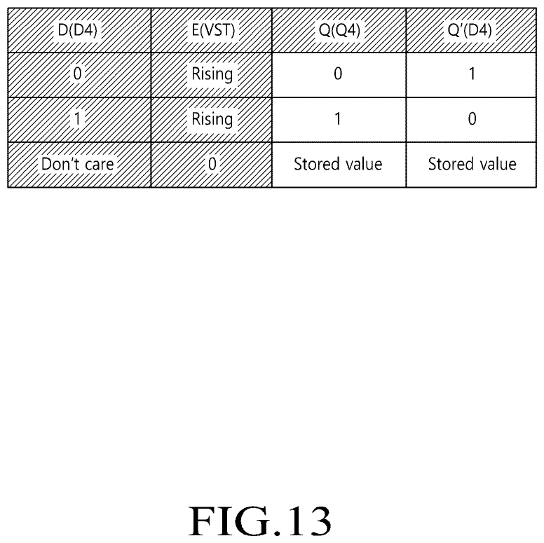

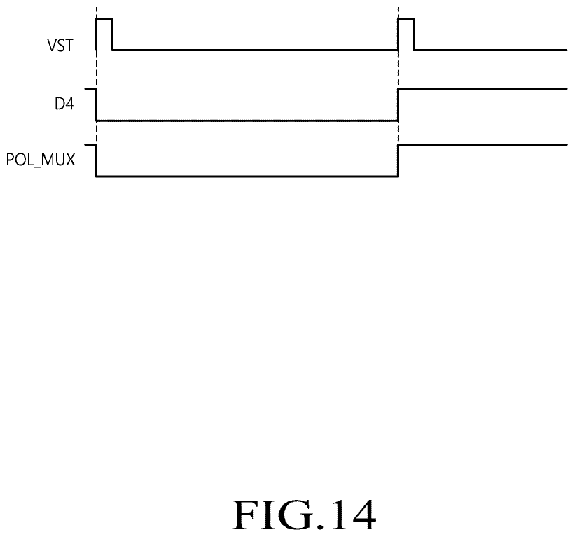

FIG. 12 illustrates another example configuration of the third logic circuit 520 according to aspects of the present disclosure. FIG. 13 illustrates an example truth table of another configuration of the third logic circuit 520 according to aspects of the present disclosure. FIG. 14 is an example timing diagram for signals generated by another configuration of the third logic circuit 520 according to aspects of the present disclosure.

As shown in FIG. 12, in one or more example embodiments, the third logic circuit 520 may include a fourth flip-flop F/F4, a fourth inverter INV4, and a fifth inverter INV5.

The fourth flip-flop F/F4 may include a fourth input node D4 and a fourth output node Q4, and can receive the start signal VST.

The fourth inverter INV4 may be connected between the fourth input node D4 and the fourth output node Q4, and can invert a signal. According to these configurations, respective signals of the fourth input node D4 and the fourth output node Q4 may be signals inverted from each other.

The fifth inverter INV5 may be connected to the fourth output node Q4. Respective signals of an output terminal of the fifth inverter INV5 and the fourth output node Q4 may be signals inverted from each other.

The signal of the output terminal of the fifth inverter INV5 may be the polarity selection signal POL_MUX. The polarity selection signal POL_MUX may be output to the polarity selection circuit MUX_POL.

As shown in FIG. 13, in one or more example embodiments, the fourth flip-flop F/F4 may be controlled according to a rising edge of the start signal VST. Whenever a rising edge of the start signal VST occurs, respective values of the fourth input node D4 and the fourth output node Q4 may be changed. For example, while the value of the signal at the fourth input node D4 is 0, when a rising edge of the start signal VST occurs, the value of the signal at the fourth input node D4 may be changed to 1 (e.g., corresponding to Q′ in the truth table), and the value of the signal at the fourth output node Q4 may be changed to 0 (e.g., corresponding to Q in the truth table). For example, while the value of the signal at the fourth input node D4 is 1, when a rising edge of the start signal VST occurs, the value of the signal at the fourth input node D4 may be changed to 0 (e.g., corresponding to Q′ in the truth table), and the value of the signal at the fourth output node Q4 may be changed to 1 (e.g., corresponding to Q in the truth table).

For example, when a rising edge of the start signal VST does not occurs, the fourth flip-flop F/F4 may have a stored value, which is not changed.

As shown in FIG. 14, in one or more example embodiments, for example, respective values of the fourth input node D4 and the fourth output node Q4 of the fourth flip-flop F/F4 may be changed when a rising edge of the start signal VST occurs.

For example, in a situation where the fourth input node D4 has a value of 1 and the fourth output node Q4 has a value of 0, when a rising edge of the start signal VST occurs, in the fourth flip-flop F/F4, the value of the fourth input node D4 may be changed to a value of 0 and the value of the fourth output node Q4 may be changed to a value of 1. The value of the polarity selection signal POL_MUX may be the value of the fourth output node Q4 inverted by the inverter.

For example, in a situation where the fourth input node D4 has a value of 0 and the fourth output node Q4 has a value of 1, when a rising edge of the start signal VST occurs, in the fourth flip-flop F/F4, the value of the fourth input node D4 may be changed to a value of 1 and the value of the fourth output node Q4 may be changed to a value of 0. The value of the polarity selection signal POL_MUX may be the value of the fourth output node Q4 inverted by the inverter. The polarity selection signal POL_MUX may be output to the polarity selection circuit MUX_POL.

FIG. 15 is an example timing diagram for selection signals generated by a logic circuit LOGIC according to aspects of the present disclosure.

As shown in FIG. 15, in one or more example embodiments, a driving period of the data driving circuit 130 may include a plurality of frame periods (1FRAME, 2FRAME . . . , and lFRAME, where l is a natural number greater than or equal to 1). Each of the plurality of frame periods (1FRAME, 2FRAME . . . , and lFRAME) may include one or more of a plurality of horizontal periods (1H, 2H, 3H, 4H, 5H, 6H . . . , and mH, where m is a natural number greater than or equal to 1). A same image may be displayed in the display area DA during one or more of the plurality of horizontal periods (1H, 2H, 3H, 4H, 5H, 6H . . . , and mH).

For example, a first selection signal MUX_SEL1 and a second selection signal MUX_SEL2 may be defined by the gate on clock signal GATE_ON_CLK. A polarity selection signal POL_MUX may be defined by the start signal VST.

For example, one period (or cycle) of the first selection signal MUX_SEL1 may equal to two horizontal periods 2H. That is, the first selection signal MUX_SEL1 may swing on a two-horizontal-period basis. For example, one period (or cycle) of the second selection signal MUX_SEL2 may equal to four horizontal periods 4H. That is, the second selection signal MUX_SEL2 may swing on a four-horizontal-period basis. For example, one period (or cycle) of the polarity selection signal POL_MUX may equal to two frame periods 2FRAME. That is, the polarity selection signal POL_MUX may swing on a two-frame-period basis. Thus, the polarity selection signal POL_MUX may be inverted whenever a period of one frame passes.

For example, four types of data voltages VDATA may be presented depending on whether each of values of the first selection signal MUX_SEL1 and the second selection signal MUX_SEL2 is 0 or 1. In addition, depending on whether the polarity selection signal POL_MUX is 0 or 1, the source driving integrated circuit SDIC may output eight types of data voltages VDATA (e.g., VDATA1 to VDATA8). When the value of the first selection signal MUX_SEL1 or the second selection signal MUX_SEL2 is 1, this may represent a logical high level. When the value of the first selection signal MUX_SEL1 or the second selection signal MUX_SEL 2 is 0, this may represent a logical low level.

While a still image is displayed on the display panel 110, a source driving integrated circuit SDIC may supply different data voltages VDATA to subpixels SP. Discussions for examples of this configuration are provided below with reference to FIG. 16 and figures following FIG. 16.

Accordingly, to display the same image on the display panel 110 during a plurality of horizontal periods in which an image data DATA is not supplied by the controller 140, the source driving integrated circuit SDIC may be needed to output a plurality of different data voltages VDATA using selection signals.

It should be noted that the eight types of data voltages, which are applied to examples discussed below, are merely one example for among a plurality of different data voltages VDATA that may be applied to these examples. A level of each of the plurality of data voltages VDATA may be determined depending on a gray level to be presented by each of a plurality of subpixels SP while a still image is displayed. The number of the plurality of data voltages VDATA may be changed depending on configurations in the selection circuit 410 and waveforms of the selection signals.

For example, a first case may be a case in which the first selection signal MUX_SEL1 and the second selection signal MUX_SEL2 have a value of 1. In the first case, while the polarity selection signal POL_MUX is 0, a first data voltage VDATA1 may be output. In the first case, while the polarity selection signal POL_MUX is 1, a second data voltage VDATA2 may be output.

For example, a second case may be a case in which the first selection signal MUX_SEL1 and the second selection signal MUX_SEL2 have a value of 0. In the second case, while the polarity selection signal POL_MUX is 0, a third data voltage VDATA3 may be output. In the second case, while the polarity selection signal POL_MUX is 1, a fourth data voltage VDATA4 may be output.

For example, a third case may be a case where the first selection signal MUX_SEL1 has a value of 0 and the second selection signal MUX_SEL2 has a value of 1. In the third case, while the polarity selection signal POL_MUX is 0, a fifth data voltage VDATA5 may be output. In the third case, while the polarity selection signal POL_MUX is 1, a sixth data voltage VDATA6 may be output.

For example, a fourth case may be a case in which the first selection signal MUX_SEL1 has a value of 1 and the second selection signal MUX_SEL2 has a value of 0. In the fourth case, while the polarity selection signal POL_MUX is 0, a seventh data voltage VDATA7 may be output. In the fourth case, while the polarity selection signal POL_MUX is 1, an eighth data voltage VDATA8 may be output.

For example, the first data voltage VDATA1 to the eighth data voltage VDATA8 may have different values, or at least two or more thereof may have an equal value.

For example, even when the first data voltage VDATA1 to the eighth data voltage VDATA8 are output from one source driving integrated circuit SDIC, the first data voltage VDATA1 to the eighth data voltage VDATA8 may be supplied to different subpixels SP depending on driving periods. According to these configurations, even when different data voltages are output from the same source driving integrated circuit SDIC, an image presented on the display panel 110 may be a still screen.

In an example where the display panel 110 is a display panel of LCD, data voltages VDATA may alternately have a level higher than a common voltage VCOM and a level lower than the common voltage VCOM periodically. Accordingly, liquid crystal cells Clc of subpixels SP may not be in a biased state. For example, depending on whether the polarity selection signal POL_MUX has a high level or a low level, any one of a level higher than the common voltage VCOM and a level lower than the common voltage VCOM may be determined.

For example, while the polarity selection signal POL_MUX is 0, the data voltage VDATA may be lower than the common voltage VCOM. While the polarity selection signal POL_MUX is 1, the data voltage VDATA may be higher than the common voltage VCOM.

In another example, while the polarity selection signal POL_MUX is 1, the data voltage VDATA may be lower than the common voltage VCOM. While the polarity selection signal POL_MUX is 0, the data voltage VDATA may be higher than the common voltage VCOM.

For example, the plurality of horizontal periods in FIG. 15 may be horizontal periods during which a still image is displayed on the display panel 110. According to these configurations, when the first data voltage VDATA1 to the eighth data voltage VDATA8 are supplied to the same subpixel SP, since the image may be changed, therefore, the first data voltage VDATA1 to the eighth data voltage VDATA8 can be supplied to different subpixels SP.

Hereinafter, discussions are provided for examples related to an order in which data voltages VDATA are supplied by source driving integrated circuits SDIC to a plurality of subpixels SP arranged in a matrix form. In this regard, during a driving period in which a still screen is presented, source driving integrated circuits SDIC may need to supply different data voltages VDATA according to periods using selection circuits. The selection signals discussed above may be used drive the selection circuits.

FIG. 16 is an example structure of the display panel 110 for sequentially supplying data voltages VDATA to a plurality of subpixels SP according to aspects of the present disclosure.

As shown in FIG. 16, in one or more example embodiments, the display panel 110 may include a plurality of data lines (DL1 to DL4), a plurality of gate lines (GL1 to GL4), and a plurality of subpixels SP.

Each of the data lines DL may be electrically connected to subpixels SP arranged in the same column among the plurality of subpixels SP. Each of the gate lines GL may be electrically connected to subpixels SP arranged in the same row among the plurality of subpixels SP.

Each of the data lines DL may deliver one or more data voltages VDATA supplied by a corresponding one of a plurality of source drive integrated circuits SDIC. The gate lines GL may deliver a gate signal to the subpixels SP on an n row basis. Here, n is a natural number greater than or equal to 1.

The plurality of subpixels SP included in the display panel 110 illustrated in FIG. 16 can sequentially receive data voltages VDATA on a column basis (i.e., in a column direction).

Accordingly, different data voltages VDATA depending on periods to display a still screen may be applied to subpixels SP to be driven to emit light as a gate signal is applied. The selection circuits may be used to supply different data voltages VDATA depending on periods, and the selection signals discussed above may be used to generate the selection circuits.

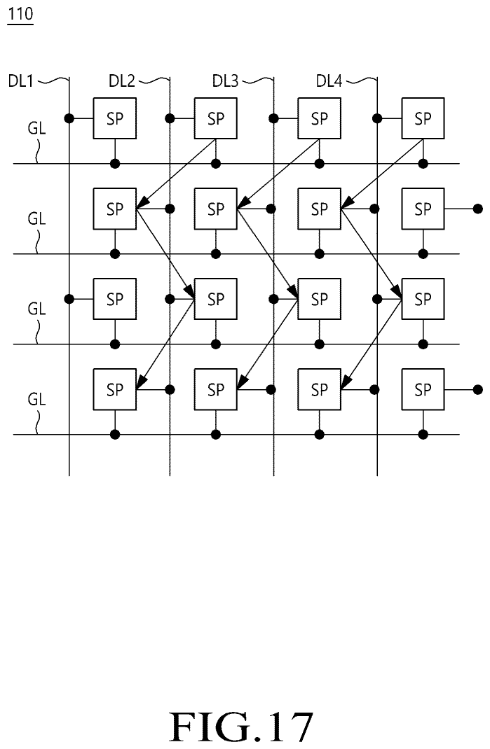

FIG. 17 is an example structure of the display panel 110 for supplying data voltages VDATA to a plurality of subpixels SP in a zigzag pattern (which may be referred to as a first type of zigzag pattern) according to aspects of the present disclosure.

As shown in FIG. 17, in one or more example embodiments, the display panel 110 may include a plurality of data lines (DL1 to DL4), a plurality of gate lines (GL1 to GL4), and a plurality of subpixels SP.

Each of the gate lines GL may be electrically connected to subpixels SP arranged in the same row among the plurality of subpixels SP. The gate lines GL may deliver a gate signal to the subpixels SP on an n row basis.

Each of the data lines DL may deliver one or more data voltages VDATA supplied by a corresponding one of a plurality of source drive integrated circuits SDIC.

Each of the data lines DL may be electrically connected to subpixels SP located alternately among subpixels SP arranged in adjacent two columns. For example, a second data line DL2 may be electrically connected to a subpixel SP arranged in a first row and a second column, a subpixel SP arranged in a second row and a first column, a subpixel SP arranged in a third row and the second column, and a subpixel SP arranged in a fourth row and the first column.

Accordingly, the plurality of subpixels SP included in the display panel 110 illustrated in FIG. 17 may receive data voltages VDATA in a zigzag pattern. For example, data voltages VDATA delivered through the second data line DL2 may be sequentially supplied to the subpixel SP arranged in the first row and the second column, the subpixel SP arranged in the second row and the first column, the subpixel SP arranged in the third row and the second column, and the subpixel SP arranged in the fourth row and the first column.

Accordingly, to supply different data voltages VDATA depending on periods to display a still image, each source drive integrated circuit SDIC may use the selection circuit. The selection signals may be used to drive the selection circuits.

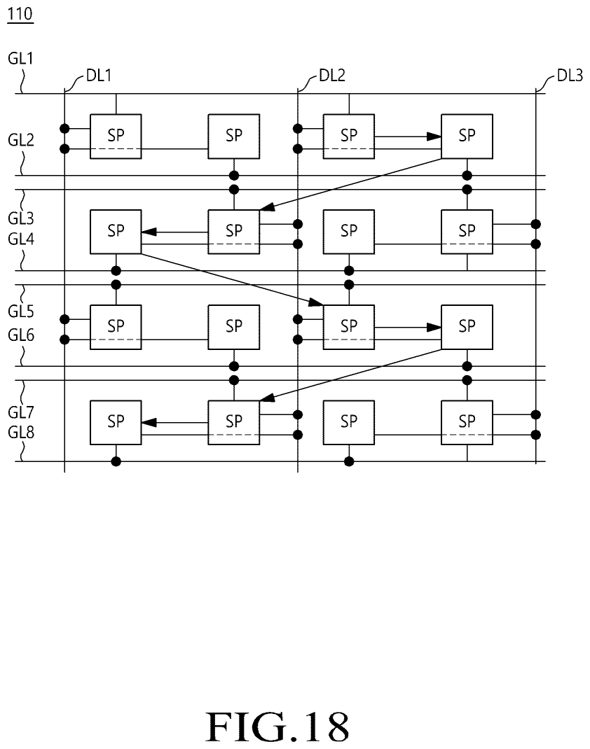

FIG. 18 is an example structure of the display panel 110 for supplying data voltages VDATA to a plurality of subpixels SP in another zigzag pattern (which may be referred to as a second type of zigzag pattern) according to aspects of the present disclosure.

As shown in FIG. 18, in one or more example embodiments, the display panel 110 may include a plurality of data lines (DL1 to DL3), a plurality of gate lines (GL1 to GL8), and a plurality of subpixels SP.

Each of the plurality of gate lines GL may be electrically connected to subpixels SP arranged in specific columns among the plurality of subpixels SP. For example, a second gate line GL2 may be electrically connected to a subpixel SP arranged in a first row and a second column, and a subpixel SP arranged in the first row and a fourth column, a third gate line GL3 may be electrically connected to a subpixel SP arranged in a second row and the second column, and a subpixel SP arranged in the second row and the fourth column. The gate lines GL may deliver a gate signal to the subpixels SP on an n row basis.

Each of the data lines DL may deliver one or more data voltages VDATA supplied by a corresponding one of a plurality of source drive integrated circuits SDIC.

Each of the data lines DL may be electrically connected to subpixels SP located alternately among subpixels SP arranged in each of respective adjacent two columns of adjacent four columns. For example, a second data line DL2 may be electrically connected to a subpixel SP arranged in a third column and the first row, the subpixel SP arranged in the fourth column and the first row, a subpixel SP arranged in the first column and the second row, the subpixel SP arranged in the second column and the second row, a subpixel SP arranged in the third column and a third row, a subpixel SP arranged in the fourth column and the third row, a subpixel SP arranged in the first column and a fourth row, and a subpixel SP arranged in the second column of the fourth row.

Accordingly, the plurality of subpixels SP included in the display panel 110 illustrated in FIG. 18 may be supplied with data voltages VDATA in a zigzag pattern larger than the zigzag pattern of FIG. 17. For example, data voltages VDATA delivered through the second data line DL2 may be sequentially supplied to the subpixel SP arranged in the third column and the first row, the subpixel SP arranged in the fourth column and the first row, the subpixel SP arranged in the first column and the second row, the subpixel SP arranged in the second column and the second row, the subpixel SP arranged in the third column and the third row, the subpixel SP arranged in the fourth column and the third row, the subpixel SP arranged in the first column and the fourth row, and the subpixel SP arranged in the second column and the fourth row.

Accordingly, to supply different data voltages VDATA depending on periods to display a still image, each source drive integrated circuit SDIC may use the selection circuit. The selection signals may be used to drive the selection circuits.

The examples, aspects, and embodiments for the display device 100 and the display panel 110 described herein may be described as follows.

According to the one or more example embodiments described herein, a display device can be provided that includes a display area in which an image is displayed and a plurality of subpixels are disposed, a non-display area located around an outer edge of the display area, a data driving circuit disposed in the non-display area and configured to supply data voltages to the plurality of subpixels, a gate driving circuit disposed in the non-display area and configured to supply a gate signal to the plurality of subpixels, and a controller configured to control the data driving circuit and the gate driving circuit.

In one or more aspects, while image data is not supplied from the controller to the data driving circuit, at least one gate control signal supplied from the controller to the gate driving circuit may be supplied to the data driving circuit, and a same image may be displayed in the display area.

In one or more aspects, the data driving circuit may include a logic circuit configured to receive the at least one gate control signal and output at least one selection signal, and a selection circuit driven based on the at least one selection signal.

In one or more aspects, the at least one gate control signal may include a gate on clock signal and a start signal.

In one or more aspects, the logic circuit may include a first logic circuit configured to output a first selection signal based on the gate on clock signal, a second logic circuit configured to receive the first selection signal from the first logic circuit and output a second selection signal based on the first selection signal, and a third logic circuit configured to output a polarity selection signal based on the start signal.

In one or more aspects, the first logic circuit may include a first flip-flop configured to operate based on the gate on clock signal and including a first input node and a first output node, and a first inverter connected between the first output node outputting the first selection signal and the first input node and inverting a signal of the first output node.

In one or more aspects, the selection circuit may include a first selection circuit configured to operate based on the first selection signal, and the data voltages output from the data driving circuit may be changed by operation of the first selection circuit.

In one or more aspects, the second logic circuit may include a second flip-flop configured to operate based on the first selection signal and including a second input node and a second output node, and a second inverter connected between the second output node outputting the second selection signal and the second input node and inverting a signal of the second output node.

In one or more aspects, the selection circuit may include a second selection circuit configured to operate based on the second selection signal, and the data voltages output from the data driving circuit may be changed by operation of the second selection circuit.

In one or more aspects, the third logic circuit may include a third flip-flop configured to operate based on the start signal, and including a third input node, a third output node, and a third inverting output node outputting the polarity selection signal, and a third inverter connected between the third output node and the third input node and inverting a signal of the third output node.

In one or more aspects, the selection circuit may include a polarity selection circuit configured to operate based on the polarity selection signal, and the data voltages output from the data driving circuit may be changed by operation of the polarity selection circuit.

In one or more aspects, the third logic circuit may include a fourth flip-flop configured to operate based on the start signal, and including a fourth input node and a fourth output node, a fourth inverter connected between the fourth output node and the fourth input node and inverting a signal of the fourth output node, and a fifth inverter connected to the fourth output node and inverting a signal of the fourth output node.

In one or more aspects, the selection circuit may include a polarity selection circuit configured to operate based on the polarity selection signal, and the data voltages output from the data driving circuit may be changed by operation of the polarity selection circuit.

In one or more aspects, a period of the first selection signal may be half a period of the second selection signal.

In one or more aspects, the polarity selection signal may be inverted when a frame of the image is changed.

According to the one or more example embodiments described herein, a display device can be provided that includes a display panel in which a plurality of subpixels are disposed, a data driving circuit configured to supply data voltages to the plurality of subpixels, a controller configured to control the data driving circuit, and a level shifter configured to receive a plurality of signals from the controller, change levels of the received plurality of signals or generate one or more other signals, and output the received plurality of signals whose levels are changed or the generated one or more signals to the display panel.

In one or more aspects, at least one signal among the plurality of signals supplied by the controller to the level shifter may be input to the data driving circuit.

In one or more aspects, the data driving circuit may include a logic circuit configured to receive the at least one signal and output at least one selection signal, and a selection circuit driven based on the at least one selection signal.

In one or more aspects, the at least one signal may include a gate on clock signal and a start signal.

In one or more aspects, the logic circuit may include a first logic circuit configured to output a first selection signal based on the gate on clock signal, a second logic circuit configured to receive the first selection signal from the first logic circuit and output a second selection signal based on the first selection signal, and a third logic circuit configured to output a polarity selection signal based on the start signal.

In one or more aspects, the selection circuit may include a first selection circuit configured to operate based on the first selection signal, a second selection circuit configured to operate based on the second selection signal, and a polarity selection circuit configured to operate based on the polarity selection signal.

In one or more aspects, the data voltages output from the data driving circuit may be changed based on operations of the first selection circuit, the second selection circuit, and the polarity selection circuit.

The above description has been presented to enable any person skilled in the art to make and use the technical idea of the present disclosure, and has been provided in the context of particular example applications and their requirements or specifications. Various modifications, additions, and substitutions to the described example embodiments will be readily apparent to those skilled in the art, and the principles described herein may be applied to other embodiments and applications without departing from the scope of the present disclosure. The above description and the accompanying drawings provide an example of the technical idea of the present disclosure for illustrative purposes only. That is, the disclosed example embodiments are intended to illustrate the technical idea of the present disclosure by way of example without limiting the scope of the present disclosure.

What is claimed is:

1. A display device, comprising:
a display area in which an image is displayed and a plurality of subpixels are disposed;
a non-display area located around an outer edge of the display area;
a data driving circuit disposed in the non-display area and configured to supply data voltages to the plurality of subpixels;
a gate driving circuit disposed in the non-display area and configured to supply at least one gate signal to the plurality of subpixels; and
a controller configured to control the data driving circuit and the gate driving circuit,
wherein, while image data is not supplied from the controller to the data driving circuit, at least one gate control signal supplied from the controller to the gate driving circuit is supplied to the data driving circuit, and a same image is displayed in the display area.

2. The display device of claim 1, wherein the data driving circuit comprises:
a logic circuit configured to receive the at least one gate control signal and output at least one selection signal; and
a selection circuit driven based on the at least one selection signal.

3. The display device of claim 2, wherein the at least one gate control signal comprises a gate on clock signal and a start signal.

4. The display device of claim 3, wherein the logic circuit comprises:
a first logic circuit configured to output a first selection signal based on the gate on clock signal;
a second logic circuit configured to receive the first selection signal from the first logic circuit and output a second selection signal based on the first selection signal; and
a third logic circuit configured to output a polarity selection signal based on the start signal.

5. The display device of claim 4, wherein the first logic circuit comprises:
a first flip-flop configured to operate based on the gate on clock signal and comprising a first input node and a first output node; and
a first inverter connected between the first output node outputting the first selection signal and the first input node and inverting a signal.

6. The display device of claim 5, wherein the selection circuit comprises a first selection circuit configured to operate based on the first selection signal, and the data voltages output from the data driving circuit are changed by operation of the first selection circuit.

7. The display device of claim 4, wherein the second logic circuit comprises:
a second flip-flop configured to operate based on the first selection signal and comprising a second input node and a second output node; and
a second inverter connected between the second output node outputting the second selection signal and the second input node and inverting a signal of the second output node.

8. The display device of claim 7, wherein the selection circuit comprises a second selection circuit configured to operate based on the second selection signal, and the data voltages output from the data driving circuit are changed by operation of the second selection circuit.

9. The display device of claim 4, wherein the third logic circuit comprises:
a third flip-flop configured to operate based on the start signal, and comprising a third input node, a third output node, and a third inverting output node outputting the polarity selection signal; and
a third inverter connected between the third output node and the third input node and inverting a signal of the third output node.

10. The display device of claim 9, wherein the selection circuit comprises a polarity selection circuit configured to operate based on the polarity selection signal, and the data voltages output from the data driving circuit are changed by operation of the polarity selection circuit.

11. The display device of claim 4, wherein the third logic circuit comprises:
a fourth flip-flop configured to operate based on the start signal, and comprising a fourth input node and a fourth output node;
a fourth inverter connected between the fourth output node and the fourth input node and inverting a signal of the fourth output node; and
a fifth inverter connected to the fourth output node and inverting a signal of the fourth output node.

12. The display device of claim 11, wherein the selection circuit comprises a polarity selection circuit configured to operate based on the polarity selection signal, and the data voltages output from the data driving circuit are changed by operation of the polarity selection circuit.

13. The display device of claim 4, wherein a period of the first selection signal is half a period of the second selection signal.

14. The display device of claim 4, which the polarity selection signal is inverted when a frame of the image is changed.

15. A display device, comprising:
a display panel in which a plurality of subpixels are disposed;
a data driving circuit configured to supply data voltages to the plurality of subpixels;
a controller configured to control the data driving circuit; and
a level shifter configured to receive a plurality of signals from the controller, change levels of the received plurality of signals or generate one or more other signals, and output the received plurality of signals whose levels are changed or the generated one or more signals to the display panel,
wherein at least one signal among the plurality of signals supplied by the controller to the level shifter is input to the data driving circuit.

16. The display device of claim 15, which the data driving circuit comprises:
a logic circuit configured to receive the at least one signal and output at least one selection signal; and
a selection circuit driven based on the at least one selection signal.

17. The display device of claim 16, wherein the at least one signal comprises a gate on clock signal and a start signal.

18. The display device of claim 17, wherein the logic circuit comprises:
a first logic circuit configured to output a first selection signal based on the gate on clock signal;
a second logic circuit configured to receive the first selection signal from the first logic circuit and output a second selection signal based on the first selection signal; and
a third logic circuit configured to output a polarity selection signal based on the start signal.

19. The display device of claim 18, wherein the selection circuit comprises:
a first selection circuit configured to operate based on the first selection signal;
a second selection circuit configured to operate based on the second selection signal; and
a polarity selection circuit configured to operate based on the polarity selection signal.

20. The display device of claim 19, wherein the data voltages output from the data driving circuit are changed based on operations of the first selection circuit, the second selection circuit, and the polarity selection circuit.
